(19) United States
(12) Patent Application Publication
(10) Pub. No.: US 2024/0351386 A1
(43) Pub. Date: Oct. 24, 2024

(54) LAND-AND-AIR MOBILE DEVICE

(71) Applicant: SUBARU CORPORATION, Tokyo (JP)

(72) Inventors: Yutaka HIWATASHI, Tokyo (JP); Sho UMEZAWA, Tokyo (JP); Tetsu NAKAZAWA, Tokyo (JP); Shoichiro SAKO, Tokyo (JP); Satoshi NARUSE, Tokyo (JP)

(21) Appl. No.: 18/708,020

(22) PCT Filed: Sep. 26, 2022
(86) PCT No.: PCT/JP2022/035704

§ 371 Date: May 7, 2024

(51) Int. Cl. B60F 5/02

(52) U.S. Cl. CPC B60F 5/02

(57) ABSTRACT

The present invention provides a land-and-air mobile device that includes an environment information acquirer configured to acquire environment information, a ground travel executor configured to execute ground travel, an air travel executor configured to execute air travel, and a controller. The controller includes one or more processors and one or more memories coupled to the one or more processors. The one or more processors are configured to execute a process including selecting, based on the environment information, a ground travel state in which the ground travel is executed or an air travel state in which the air travel is executed; and changing a priority order for information transmission related to the ground travel executor and the air travel executor in accordance with whether the ground travel state or the air travel state is selected.

### TECHNICAL FIELD

The present invention relates to a land-and-air mobile device capable of traveling on land and moving in the air.

### BACKGROUND ART

PTL 1 discloses a land-and-air vehicle capable of traveling on land and flying in the air. The land-and-air vehicle includes, on a chassis of the vehicle, a floating fan that urges air vertically downward, attitude control fans that urge air in a vertical direction, and horizontally expandable wing members.

### CITATION LIST

### Patent Literature

PTL 1: Japanese Unexamined Patent Application Publication No. 2017-185866

### SUMMARY OF INVENTION

### Technical Problem

A mobile device for land and air use has a function of traveling on the ground and a function of flying in the air as separate independent functions. Thus, it takes time to switch operation means and movement means of the mobile device when the mobile device shifts from traveling on the ground to flying in the air. In addition, the mobile device moves to a predetermined point such as a runway to switch between traveling on the ground and flying in the air.

As described above, when the function of traveling on the ground and the function of flying in the air are distinguished from each other in the mobile device, the safety on the ground and the safety in the air are independently considered, and mutual enhancement of the safety on the ground and the safety in the air is not achievable.

An object of the present invention is to provide a land-and-air mobile device for which safety can be improved.

### Solution to Problem

To overcome the above problems, a land-and-air mobile device of the present invention includes:
an environment information acquirer configured to acquire environment information;
a ground travel executor configured to execute ground travel;
an air travel executor configured to execute air travel; and
a controller.

The controller includes:
one or more processors; and
one or more memories coupled to the one or more processors.

The one or more processors are configured to execute a process including:
selecting, based on the environment information, a ground travel state in which the ground travel is executed or an air travel state in which the air travel is executed; and
changing a priority order for information transmission related to the ground travel executor and the air travel executor in accordance with whether the ground travel state or the air travel state is selected.

### Advantageous Effects of Invention

According to the present invention, safety can be improved.

### BRIEF DESCRIPTION OF DRAWINGS

FIG. 1 is a diagram illustrating a schematic configuration of a mobile device.

FIG. 2 is a functional block diagram illustrating schematic functions of a controller.

FIG. 3 is an explanatory diagram exemplifying a configuration of CAN communication.

FIG. 4 is an explanatory diagram illustrating a CAN communication frame.

FIG. 5 is an explanatory diagram illustrating a priority order for CAN communication.

FIG. 6 is another explanatory diagram illustrating a priority order for CAN communication.

FIG. 7 is a flowchart illustrating an operation of each functional module of the controller.

FIG. 8 is an explanatory diagram illustrating the operation of horizontal-direction avoidance determination processing.

FIG. 9 is an explanatory diagram illustrating the operation of avoidance direction determination processing.

### DESCRIPTION OF EMBODIMENTS

Hereinafter, an embodiment of the present invention will be described in detail with reference to the accompanying drawings. Specific dimensions, materials, numerical values, and the like illustrated in the embodiment are merely examples for facilitating understanding of the invention, and do not limit the present invention unless otherwise specified. In this specification and the drawings, elements having substantially the same functions and configurations are denoted by the same reference numerals, and redundant description thereof will be omitted. In addition, elements that are not directly related to the present invention are not illustrated in the drawings.

### (Mobile Device 100)

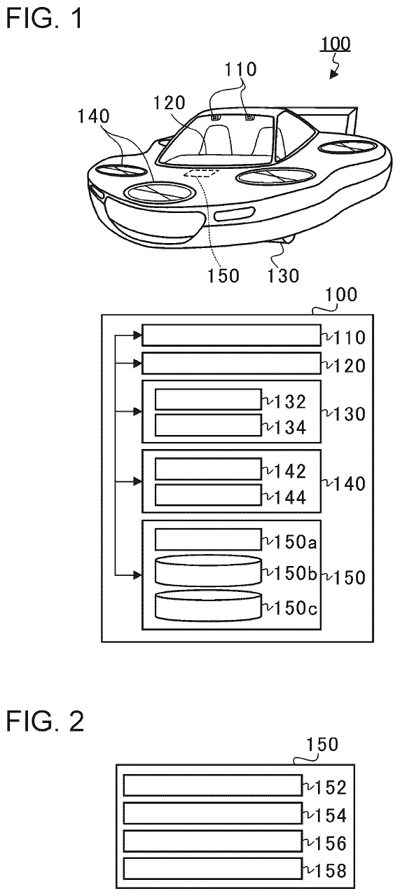

FIG. 1 is a diagram illustrating a schematic configuration of a mobile device 100. The mobile device 100 serves as a land-and-air mobile device capable of traveling on land and moving in the air. The mobile device 100 includes environment information acquirers 110, an input/output unit 120, a ground travel executor 130, an air travel executor 140, and a controller 150.

The environment information acquirers 110 acquire environment information indicating the inside and outside states of the mobile device 100 in an environment in which the mobile device 100 is located. The environment information acquirers 110 include, for example, imaging devices. Each of the imaging devices includes an imaging element such as a CCD (Charge-Coupled Device) or CMOS (Complementary Metal-Oxide Semiconductor) imaging element. The imaging devices are disposed to be spaced apart from each other in a substantially horizontal direction such that the respective optical axes of the two imaging devices are substantially parallel to each other toward the direction of travel of the mobile device 100.

Each imaging device captures an image of an external environment around the mobile device 100. The imaging device can generate a luminance image including at least luminance information. For example, the imaging device can generate a color (RGB) image or a monochrome image. The image generated by the imaging device desirably has a resolution high enough to identify, for example, electric wires between utility poles in consideration of the aerial movement of the mobile device 100. The environment information acquirers 110 further include a radar, and can acquire a relative distance between the mobile device 100 and an object located in a direction of radiation from the radar.

The environment information acquirers 110 further include an IMU (Inertial Measurement Unit). The IMU detects translational motion in three axis directions orthogonal to each other with respect to the mobile device 100, for example, velocity and acceleration. The IMU also detects rotational motion around three axes orthogonal to each other, for example, angular velocity and angular acceleration. The environment information acquirers 110 further include a GPS (Global Positioning System). The GPS can acquire the current position of the mobile device 100, for example, latitude, longitude, and altitude. The environment information acquirers 110 further include a vehicle position map service device. The vehicle position map service device can acquire, through a vehicle position map service, the position of the mobile device 100 on the map while the mobile device 100 is traveling.

The input/output unit 120 receives an operation input from an operator. The input/output unit 120 includes, for example, a driving operation unit such as an accelerator pedal and a collective lever, a braking operation unit such as a brake pedal, and a steering unit such as a steering wheel and a cyclic stick. The input/output unit 120 further includes, for example, a monitor and a speaker and outputs information on the movement of the mobile device 100 to the operator.

The ground travel executor 130 includes a power-unit bus 132 and a chassis bus 134. The power-unit bus 132 includes an ECU (Electronic Control Unit) related to a power unit, a driving mechanism, and a braking mechanism. The power-unit bus 132 generates a driving force and a braking force for the mobile device 100 in accordance with operation inputs received by the driving operation unit and the braking operation unit. The chassis bus 134 includes an ECU related to a chassis, and a steering mechanism. The chassis bus 134 changes the direction of travel of the mobile device 100 in accordance with an operation input received by the steering unit. Such movements on the ground may be referred to as ground travel.

The air travel executor 140 includes a motor bus 142 and a three-steering bus 144. The motor bus 142 includes an ECU related to a motor, and a driving mechanism. The motor bus 142 generates thrust and lift for the mobile device 100 in accordance with an operation input received by the driving operation unit. The three-steering bus 144 includes an ECU that controls the pitch, roll, and yaw of the mobile device 100, and a steering mechanism. When the mobile device 100 is a fixed-wing device, the three-steering bus 144 may include an ECU that controls ailerons, a rudder, and an elevator, and a steering mechanism. The three-steering bus 144 changes the altitude and the propulsion direction of the mobile device 100 in accordance with an operation input received by the steering unit.

The air travel executor 140 can propel the mobile device 100 in the air to an altitude of, for example, 200 m to 300 m. In the present embodiment, the mobile device 100 can move in the air with the lift force maintained, and can, in addition, temporarily move in the air with a short-time lift force. That is, the mobile device 100 can perform a jump. Such movements in the air may be referred to as air travel.

The controller 150 is constituted by a semiconductor integrated circuit including a processor 150a, a ROM 150b that stores a program and the like, a RAM 150c serving as a work area, and so on. The controller 150 is coupled to the environment information acquirers 110, the input/output unit 120, the ground travel executor 130, and the air travel executor 140 through a predetermined communication means. The controller 150 controls the entire mobile device 100 through the predetermined communication means. In addition, from the viewpoint of substantially controlling the execution of ground travel or air travel, the ECUs included in the mobile device 100, including the ECU of the ground travel executor 130 and the ECU of the air travel executor 140 described above, also serve as the controller 150.

Various existing communication standards such as CAN (Controller Area Network), CAN-FD (CAN with Flexible Data Rate), FlexRay, Ethernet, and LIN (Local Interconnect Network) can be adopted as the predetermined communication means. In the present embodiment, of such communication means, CAN communication will be described for convenience of description. However, the present invention is not limited to such a case, and it goes without saying that CAN communication can be used interchangeably with any other communication means.

In the present embodiment, both the ground travel executor 130 and the air travel executor 140 are provided in one mobile device 100. This configuration allows a person to use both ground and air routes as travel routes. In one example, the mobile device 100 provides increased flexibility of movement to a person, resulting in an expanded movement network.

FIG. 2 is a functional block diagram illustrating schematic functions of the controller 150. In the controller 150, the processor 150a serves as functional modules such as an environment information analyzer 152, a ground travel controller 154, an air travel controller 156, and a travel selector 158 in cooperation with a program included in the ROM 150b. The environment information analyzer 152, the ground travel controller 154, the air travel controller 156, and the travel selector 158 may each be implemented by multiple ECUs that serve as the controller 150, rather than by a single device. The environment information analyzer 152, the ground travel controller 154, the air travel controller 156, and the travel selector 158 can perform communication by using CAN communication.

The environment information analyzer 152 analyzes the environment information acquired by the environment information acquirers 110. For example, the environment information analyzer 152 generates a distance image from two luminance images acquired by the imaging devices serving as the environment information acquirers 110, and recognizes the surrounding environment of the mobile device 100 to generate surrounding information.

In one example, the environment information analyzer 152 searches for a block corresponding to any block extracted from one of the luminance images from the other luminance image by using so-called pattern matching, and derives parallax information in accordance with a distance in the horizontal direction from the one luminance image. The environment information analyzer 152 performs processing for such per-block derivation of the parallax information on all blocks in the luminance image.

The environment information analyzer 152 converts the parallax information for each block in the luminance image into a relative distance (z) by using a so-called stereo method and derives three-dimensional position information, that is, a horizontal distance (x), a vertical distance (y), and the relative distance (z). The derived three-dimensional position information is associated with the luminance image to produce an image that is the distance image. The stereo method is a method of deriving a relative distance of a block with respect to the imaging device from a parallax of the block by using a triangulation method.

The environment information analyzer 152 uses the luminance images and the distance image, which are derived as described above, to recognize the external environment. For example, the environment information analyzer 152 identifies a three-dimensional object located around and ahead of the mobile device 100 as a specific object such as a preceding vehicle. The environment information analyzer 152 further derives a relative distance between the mobile device 100 and a three-dimensional object around the mobile device 100, based on environment information acquired by the radar. In this way, surrounding information indicating the surrounding environment of the mobile device 100 is generated.

The environment information analyzer 152 further derives movement information of the mobile device 100, based on environment information acquired by the IMU. For example, the environment information analyzer 152 derives a movement direction, a movement speed, a movement acceleration, a rotation direction, a rotation angle, a rotation angular velocity, and a rotation angular acceleration of the mobile device 100. Further, the environment information analyzer 152 derives attitude information of the mobile device 100, for example, a front direction and an attitude indicated by a pitch angle, a roll angle, and a yaw angle, based on the environment information acquired by the IMU. The environment information analyzer 152 further derives position information of the mobile device 100, for example, latitude, longitude, and altitude, based on environment information acquired by the GPS and the vehicle position map service.

The ground travel controller 154 controls the speed and the steering angle of the mobile device 100 during ground travel, based on operation information received from the input/output unit 120, the surrounding information indicating the surrounding environment of the mobile device 100, and the movement information, the attitude information, and the position information of the mobile device 100. The ground travel controller 154 can reduce damage caused by a collision with the preceding vehicle and can perform tracking control to maintain a safe inter-vehicle distance between the mobile device 100 and the preceding vehicle. In such ground travel, the operation of the ground travel controller 154 complies with automobile regulations such as the Road Traffic Act.

The air travel controller 156 controls the speed, the propulsion direction, and the altitude of the mobile device 100 during air travel, based on the operation information, the surrounding information, and the movement information, the attitude information, and the position information of the mobile device 100. Further, the air travel controller 156 performs attitude control of the mobile device 100 during air travel to keep an occupant in a safe position, based on the movement information and the attitude information of the mobile device 100.

The travel selector 158 selects a ground travel state or an air travel state as a travel state of the mobile device 100, based on the operation information received from the input/output unit 120 or the surrounding information and the movement information. As described below, the travel selector 158 at least changes the priority order for information transmission related to the ground travel executor 130 and the air travel executor 140 in accordance with whether the ground travel state or the air travel state is selected. The change of the priority order can shift the mobile device 100 from the ground travel state to the air travel state or can make the mobile device 100 in the air travel state land on the ground and shift the mobile device 100 to the ground travel state. Here, CAN communication, which is a communication means for transmitting information to the ground travel executor 130 and the air travel executor 140, will be described first, and then the priority order for CAN communication will be described in detail as an example of the priority order for information transmission.

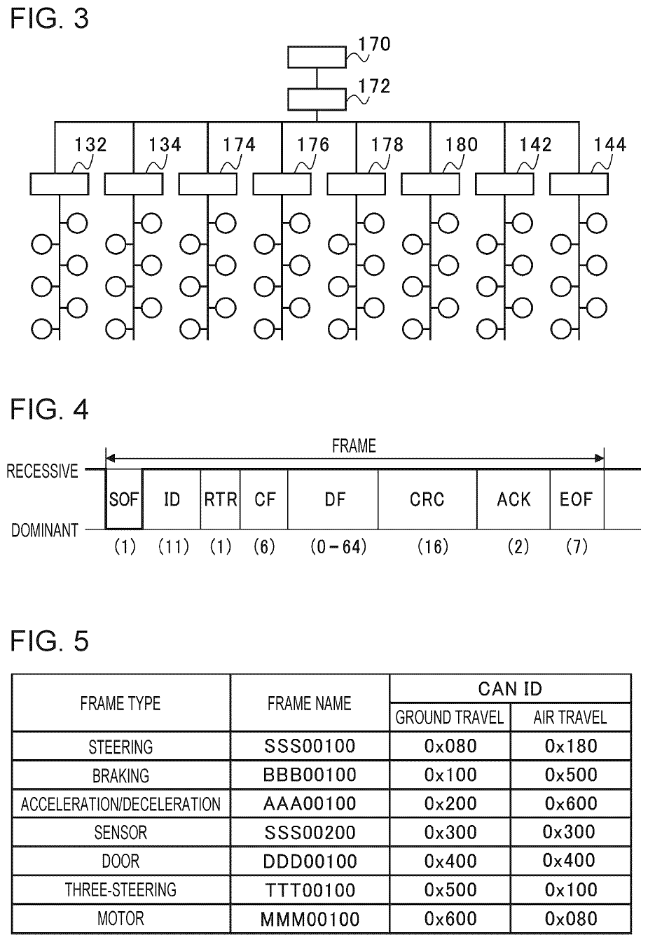

FIG. 3 is an explanatory diagram exemplifying a configuration of CAN communication. A DCM (Data Communication Module) 170 establishes communication with a server outside a vehicle and acquires various types of information to be used for traveling. Further, the DCM 170 notifies an occupant in the vehicle of information. A CGW (Central Gateway) 172 relays access between ECUs coupled to each bus in CAN communication. The CGW 172 further relays access between the communication standards in the mobile device 100, for example, CAN, CAN-FD, FlexRay, Ethernet, and LIN. For example, the CGW 172 converts a frame in a communication standard supported by a transmission source into a frame in a communication standard supported by a transmission destination of the frame and outputs the frame in the communication standard supported by the transmission destination. The frame is a unit of data to be transmitted and received in CAN communication. Here, access between ECUs coupled to each bus in CAN communication will be described as an example. In response to receipt of a frame whose transmission destination is a different bus, the CGW 172 stores the frame in a FIFO coupled to the transmission destination bus. The FIFO transmits frames accumulated according to the transmission rate to ECUs coupled to the transmission destination bus.

The CGW 172 is coupled to multiple CAN communication buses, namely, the power-unit bus 132, the chassis bus 134, an environment bus 174, a body bus 176, a cockpit bus 178, a diagnosis bus 180, the motor bus 142, and the three-steering bus 144. The power-unit bus 132 performs drive control of one or both of an engine and the motor. The chassis bus 134 controls the direction of travel of the mobile device 100. The environment bus 174 supports travel of the mobile device 100, based on the environment information acquired by the environment information acquirers 110 and an analysis result of the environment information analyzer 152. The body bus 176 supports movement of a sliding door or a side window. The cockpit bus 178 controls an operation of a navigation system or the like. The diagnosis bus 180 is used for testing the mobile device 100. The motor bus 142 performs drive control of the motor. The three-steering bus 144 controls the propulsion direction of the mobile device 100. Each bus is coupled to multiple ECUs indicated by white circles (“∘”) in FIG. 3.

The protocol for CAN communication is a multi-master protocol. A single ECU occupying a bus can transmit a frame to a transmission destination ECU. CAN communication adopts an event-driven architecture. Thus, if multiple ECUs transmit frames at the same time in the same transmission cycle, collisions may occur between the frames. Here, arbitration is performed based on CAN IDs. The CAN IDs are identifiers of the frames. Thus, a frame with a high-priority CAN ID wins the right to be transmitted appropriately. In other words, a frame with a low-priority CAN ID fails to be transmitted for a period of time during which a frame with a high-priority CAN ID is transmitted. The transmission of a low-priority frame is executed during an idle time after the transmission of a high-priority frame is completed and before the next high-priority frame is transmitted. Here, the CAN IDs are set such that a frame for processing with high impact on the safety of the mobile device 100 and for real-time transmission is assigned a high priority.

FIG. 4 is an explanatory diagram illustrating a CAN communication frame. In CAN communication, two values are used: dominant “0” and recessive “1”. In CAN communication, a dominant signal has priority over a recessive signal when a collision occurs. As illustrated in FIG. 4, the CAN communication frame includes SOF, ID, RTR, CF, DF, CRC, ACK, and EOF. The SOF (Start Of Frame) is represented by 1 dominant bit and indicates the start position of communication.

The ID is represented by 11 bits (0x00 to 0x7FF) and indicates an identifier of the frame and the priority order for communication arbitration. In CAN communication, the ID is expressed as a CAN ID in the present embodiment. A numerical value with “0x” at the head thereof indicates a hexadecimal number. In CAN communication, the smaller the numerical value of the CAN ID, the higher the priority. In one example, a transmission source ECU from which a frame is transmitted detects the CAN ID of the transmitted frame on a bit-by-bit basis, and determines whether the detected CAN ID is equal to the CAN ID transmitted by the ECU. In CAN communication, since dominant has priority over recessive, a certain CAN ID is not maintained when another CAN ID has a higher priority than the certain CAN ID. The transmission source ECU stops the transmission of the frame when it is determined that the detected CAN ID is different from the CAN ID of the transmitted frame. In this way, even if frames collide with each other, the frame having a higher priority, that is, the frame having a smaller CAN ID value, is transmitted appropriately.

The RTR (Remote Transmission Request) is represented by 1 bit and identifies a frame (dominant) and a remote frame (recessive). The CF (Control Field) is composed of 6 bits and indicates a data length. The DF (Data Field) is represented by 0 to 64 bits and stores the data itself. The CRC (Cyclic Redundancy Check) is represented by 16 bits and indicates the CRC sequence of the data up to the CRC and the end thereof (delimiter). The ACK is represented by 2 bits and indicates the result of whether the data up to the CRC has been normally received and the end thereof (delimiter). The EOF (End Of Frame) is represented by 7 bits and indicates the end of the frame.

In CAN communication, an extension format obtained by extending the frame in FIG. 4 may be used. In the extension format, the ID portion in FIG. 4 is extended to a base ID, SRR, IDE, and an extended ID. Like the ID, the base ID is represented by 11 bits and indicates an identifier of a frame or an ECU and the priority order for communication arbitration. The SRR (Substitute Remote Request Bit) is represented by 1 recessive bit. The IDE (Identifier Extension Bit) is represented by 1 recessive bit. The extended ID is represented by 18 bits. The base ID and the extended ID are combined together to form a 29-bit identifier.

The transmission source ECU transmits a frame to which a CAN ID is attached. Each ECU uses the CAN ID to identify whether the frame is a frame to be used by the ECU.

An aircraft typically flies by using a module dedicated to the aircraft. The module dedicated to the aircraft tends to be high in cost because of low versatility. Here, automotive CAN communication having high versatility is adopted for the mobile device 100 to use an automotive module. Further, a DCM and cockpit parts are also shared to implement air travel. Thus, the cost can be reduced.

In CAN communication, as described above, priorities are determined for respective frames by CAN IDs. In the mobile device 100, to implement ground travel, for example, priorities are determined according to the ASIL (Automotive Safety Integrity Level). The air travel of the mobile device 100 is implemented by using a steering mechanism and a driving mechanism different from those for ground travel. In the mobile device 100, therefore, the priorities of the frames to be used during ground travel and air travel are changed between the ground travel and the air travel. Accordingly, the travel selector 158 changes the priority order for CAN communication to the ground travel executor 130 and the air travel executor 140 in accordance with whether the ground travel state or the air travel state is selected.

FIG. 5 is an explanatory diagram illustrating a priority order for CAN communication. Here, a frame type, a frame name, and a CAN ID are associated with each other for each frame.

As in FIG. 5, the priority order for CAN communication to the ground travel executor 130 and the air travel executor 140 differs in accordance with whether the mobile device 100 travels on the ground or travels in the air. For example, when the mobile device 100 travels on the ground, a CAN ID is set in each frame as follows. The frame type “steering”, which is mainly processed by the ECU in the chassis bus 134, is associated with the CAN ID “0x080”. The frame type “braking”, which is mainly processed by the ECU in the power-unit bus 132, is associated with the CAN ID “0x100”. The frame type “acceleration/deceleration”, which is mainly processed by the ECU in the power-unit bus 132, is associated with the CAN ID “0x200”. The frame type “sensor”, which is mainly processed by the ECU in the environment bus 174, is associated with the CAN ID “0x300”. The frame type “door”, which is mainly processed by the ECU in the body bus 176, is associated with the CAN ID “0x400”. The frame type “three-steering”, which is mainly processed by the ECU in the three-steering bus 144, is associated with the CAN ID “0x500”. The frame type “motor”, which is mainly processed by the ECU in the motor bus 142, is associated with the CAN ID “0x600”.

Accordingly, in the example in FIG. 5, when the mobile device 100 travels on the ground, the priorities in descending order are as follows: the frame type “steering”; the frame type “braking”; the frame type “acceleration/deceleration”; the frame type “sensor”; the frame type “door”; the frame type “three-steering”; and the frame type “motor”. In this way, the processes of the ground travel executor 130 are preferentially executed during ground travel. In the ground travel executor 130, it can be understood that the priorities in descending order are as follows: changing the movement direction; braking; and traveling.

When the mobile device 100 travels in the air, a CAN ID is set in each frame as follows. The frame type “steering” is associated with the CAN ID “0x180”. The frame type “braking” is associated with the CAN ID “0x500”. The frame type “acceleration/deceleration” is associated with the CAN ID “0x600”. The frame type “sensor” is associated with the CAN ID “0x300”. The frame type “door” is associated with the CAN ID “0x400”. The frame type “three-steering” is associated with the CAN ID “0x100”. The frame type “motor” is associated with the CAN ID “0x080”.

Accordingly, in the example in FIG. 5, when the mobile device 100 travels in the air, the priorities in descending order are as follows: the frame type “motor”; the frame type “three-steering”; the frame type “steering”; the frame type “sensor”; the frame type “door”; the frame type “braking”, and the frame type “acceleration/deceleration”. In this way, the processes of the air travel executor 140 are preferentially executed during air travel. In the air travel executor 140, it can be understood that the priorities in descending order are as follows: maintaining the levitation state; changing the movement direction; and braking.

Referring to FIG. 5, frames to be transmitted from the ECUs each have respective CAN IDs for ground travel and air travel. Further, a frame assigned the same priority for ground travel and air travel, such as frames with the frame type “sensor” and the frame type “door”, is assigned CAN IDs having the same value.

The travel selector 158 selects the ground travel state or the air travel state in accordance with the environment information. For example, if it is determined in the ground travel state that a shift is to be made to the air travel state, the travel selector 158 switches from the ground travel state to the air travel state. If it is determined in the air travel state that a shift is to be made to the ground travel state, the travel selector 158 switches from the air travel state to the ground travel state. In addition to such automatic determination, the travel selector 158 can further switch between the ground travel state and the air travel state in accordance with an operation of the occupant.

In response to a switch in the travel state, the priority order for CAN communication is switched as in FIG. 5. For example, when a change from the ground travel state to the air travel state is determined, the travel selector 158 transmits a frame indicating that the change to air travel is determined to each ECU. Each ECU switches the CAN IDs for the frame type “steering”, the frame type “braking”, the frame type “acceleration/deceleration”, the frame type “three-steering”, and the frame type “motor” from “0x080”, “0x100”, “0x200”, “0x500”, and “0x600” to “0x180”, “0x500”, “0x600”, “0x100”, and “0x080”, respectively. Note that the CAN IDs for the frame type “sensor” and the frame type “door” are maintained as “0x300” and “0x400”, respectively. For each of the frame types “sensor” and “door”, CAN IDs having the same value, which are prepared, may be switched, or one CAN ID may be fixedly used. In this way, the priority order for CAN communication is switched, and as a result, the driving subject is switched from the ground travel executor 130 to the air travel executor 140.

Here, the CAN ID of a frame to be transmitted from the travel selector 158 in response to a change from the ground travel state to the air travel state and the CAN ID of a frame to be transmitted from the travel selector 158 in response to a change from the air travel state to the ground travel state are set to be the highest priority value, for example, “0x00” regardless of any of the air travel state and the ground travel state. Accordingly, a frame indicating that a change has been determined is transmitted to each ECU with the highest priority. This makes it possible to smoothly switch between the air travel state and the ground travel state.

In the foregoing description, an example has been described in which the CAN IDs in FIG. 5 are switched at the same time in response to the travel selector 158 performing a process of switching the priority order for information transmission. However, the present invention is not limited to such a case, and the CAN IDs may be switched at different timings according to priority. For example, in a change from the ground travel state to the air travel state, the travel selector 158 switches the CAN ID for the frame type “motor” earliest to levitate the mobile device 100 first. In a change from the air travel state to the ground travel state, the mobile device 100 continues traveling in the air for a period of time during which the mobile device 100 can possibly rise up again. In a change from the air travel state to the ground travel state, accordingly, the travel selector 158 does not switch the CAN ID for the frame type “motor” for a period of time during which the mobile device 100 can possibly rise up again, and switches the CAN ID after the mobile device 100 lands and reliably shifts to the ground travel state.

In this way, if a time difference is provided in switching between CAN IDs, as in FIG. 5, a CAN ID for ground travel and a CAN ID for air travel may temporarily have the same value, resulting in a collision of frames. For frames whose CAN IDs may overlap at the same timing, the CAN IDs thereof are made different. For example, in a change from the air travel state to the ground travel state, the CAN ID “0x080” for the frame type “motor” and the CAN ID “0x080” for the frame type “steering” may collide with each other. In this case, the ECUs may set the CAN ID of one of the frames to, for example, “0x090” instead of “0x080”.

If CAN IDs can possibly overlap at the same timing, each ECU may temporarily set, in one frame, a CAN ID for shifting and may set the correct CAN ID in the one frame after switching of the CAN ID of the other frame is completed. For example, in a change from the air travel state to the ground travel state, the CAN ID “0x080” for the frame type “motor” and the CAN ID “0x080” for the frame type “steering” may collide with each other. Accordingly, the CAN ID for the frame type “motor” may be temporarily changed from “0x080” to “0x090” to avoid duplication with the CAN ID “0x080” for the frame type “steering”. Thereafter, after the mobile device 100 lands and reliably shifts to the ground travel state, the CAN ID for the frame type “motor” may be changed to “0x600”.

In the foregoing description, an example has been described in which a priority is determined for each frame. However, the present invention is not limited to such a case. For example, a priority may be determined for each bus.

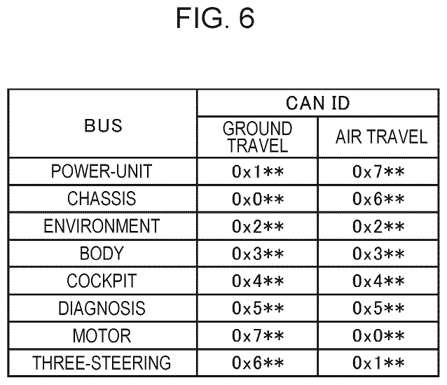

FIG. 6 is another explanatory diagram illustrating a priority order for CAN communication. Here, each bus is associated with the upper 3 bits of a CAN ID. Thus, the priorities of the buses are determined by the upper 3 bits. In each bus, the priority order is determined by the lower 8 bits. In FIG. 6, “*” indicates that any numerical value is determined in the bus.

For example, when the mobile device 100 travels on the ground, a CAN ID is set in each bus as follows. The power-unit bus 132 is associated with the CAN ID “0x1**”. The chassis bus 134 is associated with the CAN ID “0x0**”. The environment bus 174 is associated with the CAN ID “0x2**”. The body bus 176 is associated with the CAN ID “0x3**”. The cockpit bus 178 is associated with the CAN ID “0x4**”. The diagnosis bus 180 is associated with the CAN ID “0x5**”. The motor bus 142 is associated with the CAN ID “0x7**”. The three-steering bus 144 is associated with the CAN ID “0x6**”.

Accordingly, in the example in FIG. 6, when the mobile device 100 travels on the ground, the priorities in descending order are as follows: the chassis bus 134, the power-unit bus 132, the environment bus 174, the body bus 176, the cockpit bus 178, the diagnosis bus 180, the three-steering bus 144, and the motor bus 142.

When the mobile device 100 travels in the air, a CAN ID is set in each bus as follows. The power-unit bus 132 is associated with the CAN ID “0x7**”. The chassis bus 134 is associated with the CAN ID “0x6**”. The environment bus 174 is associated with the CAN ID “0x2**”. The body bus 176 is associated with the CAN ID “0x3**”. The cockpit bus 178 is associated with the CAN ID “0x4**”. The diagnosis bus 180 is associated with the CAN ID “0x5**”. The motor bus 142 is associated with the CAN ID “0x0**”. The three-steering bus 144 is associated with the CAN ID “0x1**”.

Accordingly, in the example in FIG. 6, when the mobile device 100 travels in the air, the priorities in descending order are as follows: the motor bus 142, the three-steering bus 144, the environment bus 174, the body bus 176, the cockpit bus 178, the diagnosis bus 180, the chassis bus 134, and the power-unit bus 132.

Here, as in the description with reference to FIG. 5, in response to switching between the ground travel state and the air travel state, the travel selector 158 transmits a frame indicating that the travel state has been changed to each ECU to switch between the ground travel state and the air travel state. However, the present invention is not limited to such a case. The ground travel state and the air travel state can also be switched by replacement of a CAN ID at the CGW 172.

For example, in the ground travel state, the CGW 172 transmits a frame received from any bus to another bus as it is. In the air travel state, in contrast, upon receipt of frames from the power-unit bus 132, the chassis bus 134, the motor bus 142, and the three-steering bus 144, the CGW 172 rewrites the numerical values of the upper 3 bits thereof and transmits the frames to another bus. For example, in the ground travel state, the CGW 172 transmits a frame received from the power-unit bus 132 to another bus as it is. In the air travel state, in contrast, the CGW 172 replaces the upper 3 bits “0x1” of the CAN ID of the frame received from the power-unit bus 132 with “0x7” and transmits the frame to another bus.

With this configuration, each ECU does not change a CAN ID, and thus the program size and the processing load can be reduced.

### (External Environment Recognition Method)

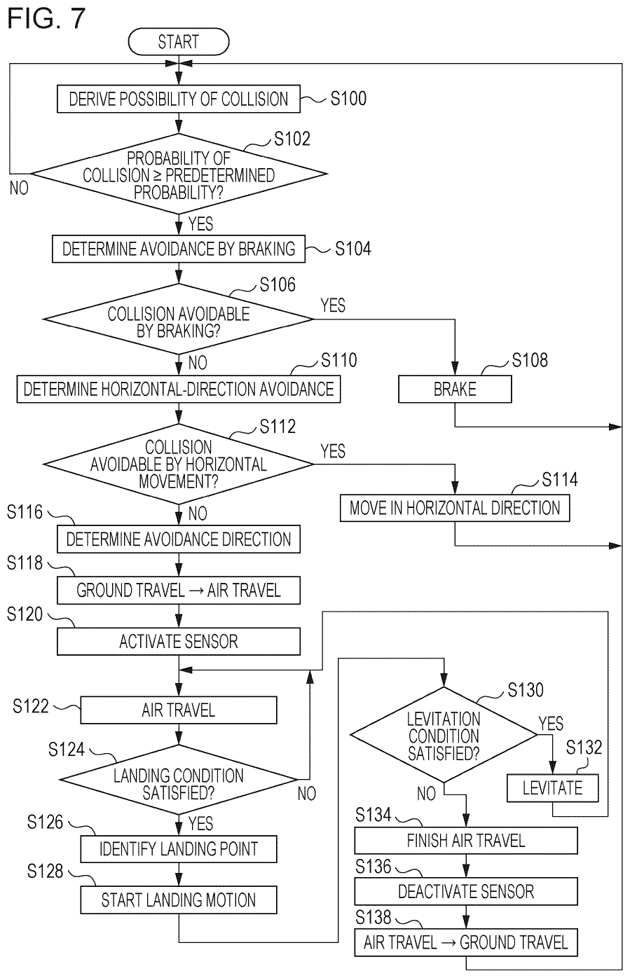

FIG. 7 is a flowchart illustrating an operation of each functional module of the controller 150. Here, a description will be given of an example in which the mobile device 100 temporarily travels in the air upon satisfying a predetermined condition during ground travel.

The ground travel controller 154 controls the ground travel executor 130 in accordance with the operation information received from the input/output unit 120 to perform the ground travel of the mobile device 100. During the ground travel, the environment information analyzer 152 derives the possibility of collision of the mobile device 100 at predetermined intervals (S100). In one example, the environment information analyzer 152 derives the surrounding information and the movement information based on the environment information acquired by the environment information acquirers 110, and identifies an obstacle located around the mobile device 100 and having a possibility of collision. Examples of the obstacle include a vehicle, a bicycle, a person, a sign, a guardrail, and a building. The environment information analyzer 152 derives the probability of collision with the obstacle, based on the identified obstacle.

The environment information analyzer 152 further derives a relative speed, a relative direction, and a collision time TTC (time to collision) with respect to the obstacle from the position of the mobile device 100, the absolute speed of the mobile device 100, the direction of travel of the mobile device 100, the position of the obstacle, the absolute speed of the obstacle, and the direction of travel of the obstacle at the point in time when the probability of collision is derived.

The environment information analyzer 152 repeats step S100 while there is no possibility that the mobile device 100 collides with the obstacle, that is, while the probability of collision with the obstacle is less than a predetermined probability (NO in S102). On the other hand, if it is determined that there is a possibility that the mobile device 100 collides with the obstacle, that is, the probability of collision with the obstacle is equal to or higher than the predetermined probability (YES in S102), the environment information analyzer 152 determines whether the collision with the obstacle is avoidable by braking the mobile device 100 (S104). If it is determined as a result that the collision with the obstacle is avoidable by braking the mobile device 100 (YES in S106), the ground travel controller 154 brakes the mobile device 100 through the ground travel executor 130 (S108). On the other hand, if it is determined that the collision is not avoidable by braking the mobile device 100 (NO in S106), the environment information analyzer 152 determines whether the collision is avoidable by moving the mobile device 100 in the horizontal direction with respect to the obstacle (S110).

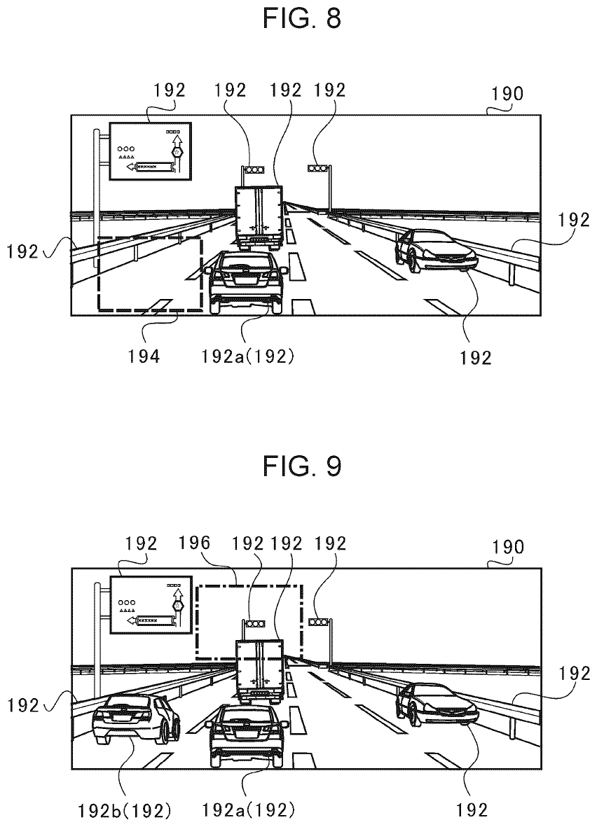

FIG. 8 is an explanatory diagram illustrating the operation of the horizontal-direction avoidance determination processing S110. Here, a description will be given of a luminance image 190 captured by an imaging device as the surrounding information. Obstacles 192 to be controlled include, for example, mobile devices such as a preceding vehicle and an oncoming vehicle, and fixed objects such as signs, guardrails, and traffic lights. If it is determined that the probability of collision with an obstacle 192a, which is any one of the obstacles 192 and is located around the mobile device 100, is equal to or higher than the predetermined probability and it is determined that the collision is not avoidable even by braking the mobile device 100, the environment information analyzer 152 determines whether the mobile device 100 is movable in the horizontal direction.

The environment information analyzer 152 extracts a region in which none of the obstacles 192 is present and to which the mobile device 100 is movable, for example, a left region 194 surrounded by a broken line in FIG. 8, based on the surrounding information, the movement information, the attitude information, and the position information. The environment information analyzer 152 determines the extracted region as an avoidance region. If such an avoidance region can be determined, the collision is avoidable by moving the mobile device 100 in the horizontal direction with respect to the obstacle 192. If such an avoidance region cannot be determined, the collision is not avoidable even by moving the mobile device 100 in the horizontal direction with respect to the obstacle 192.

Referring back to FIG. 7, if it is determined that the collision is avoidable by moving the mobile device 100 in the horizontal direction with respect to an obstacle 192 (YES in S112), the ground travel controller 154 moves the mobile device 100 to the determined avoidance region through the ground travel executor 130 (S114).

On the other hand, if it is determined that the collision is not avoidable even by moving the mobile device 100 in the horizontal direction with respect to the obstacle 192 (NO in S112), the environment information analyzer 152 determines to propel the mobile device 100 in the vertically upward direction with respect to the obstacle 192, and determines the propulsion direction of the mobile device 100 (S116).

FIG. 9 is an explanatory diagram illustrating the operation of the avoidance direction determination processing S116. Here, a description will be given of a luminance image 190 captured by an imaging device as the surrounding information. If it is determined that the probability of collision with one of the obstacles 192, namely, the obstacle 192a, is equal to or higher than the predetermined probability, it is determined that the collision is not avoidable even by braking the mobile device 100, and it is determined that the collision is not avoidable even by moving the mobile device 100 in the horizontal direction because another obstacle 192b is present, the environment information analyzer 152 determines to cause the mobile device 100 to escape in the vertically upward direction. The environment information analyzer 152 extracts a region in which none of the obstacles 192 is present and to which the mobile device 100 is movable, for example, an upper region 196 surrounded by a dot-dash line in FIG. 9, based on the surrounding information, the movement information, the attitude information, and the position information. The environment information analyzer 152 determines the extracted region as an avoidance region.

Referring back to FIG. 7, the travel selector 158 switches from the ground travel state to the air travel state in response to a determination that the mobile device 100 is to move in the vertically upward direction (S118).

In one example, as illustrated in FIG. 5, the travel selector 158 changes the priority order for CAN communication from the priority order based on the ground travel state to the priority order based on the air travel state.

Further, the environment information analyzer 152 activates a sensor related to environment information to be detected in the air travel state (S120). In one example, the environment information analyzer 152 activates an imaging device or a radar installed toward the vertically lower side of the mobile device 100 to acquire environment information of the surroundings vertically below the mobile device 100. For example, in the case of an aircraft such as a helicopter, the conditions in the vertically downward direction may be observed when the aircraft is hovering. In the case of an automobile traveling on a road, however, the distance to the road vertically below is always constant, and the conditions in the vertically downward direction are not observed or predicted. It is assumed here that the mobile device 100 travels on the ground. However, the environment information analyzer 152 acquires environment information of the surroundings vertically below the mobile device 100 to observe the surroundings during air travel.

Here, a description will be given of an example in which in response to switching to the air travel state, the environment information analyzer 152 newly activates an imaging device or a radar to acquire environment information of the surroundings vertically below the mobile device 100. However, the present invention is not limited to such a case. The environment information analyzer 152 may expand a detection target range of an imaging device or a radar installed toward the direction of travel to the surroundings vertically below the mobile device 100 and acquire environment information of the surroundings vertically below the mobile device 100. Alternatively, the environment information analyzer 152 may rotate the imaging device or the radar in the pitch direction and change the detection target range to the vertically lower side of the mobile device 100 to acquire environment information of the surroundings vertically below the mobile device 100. This configuration does not provide an additional imaging device or radar, resulting in a reduction in cost.

Further, a description will be given of an example in which in response to switching to the air travel state, the environment information analyzer 152 activates an imaging device or a radar to additionally acquire environment information of the surroundings vertically below the mobile device 100. However, the present invention is not limited to such a case. The environment information acquirers 110 may always acquire information on all environments including the surroundings vertically below the mobile device 100. In response to switching to the air travel state, the environment information analyzer 152 may switch environment information to be extracted from the information on the environments acquired by the environment information acquirers 110. This configuration can reduce the time taken to acquire the environment information of the surroundings vertically below the mobile device 100.

Subsequently, the air travel controller 156 causes the mobile device 100 to start traveling in the air and maintains the air travel state through the air travel executor 140 (S122). Here, the air travel controller 156 propels the mobile device 100 vertically upward from the obstacle 192 to avoid collision with the obstacle 192. However, as described above, the altitude of the mobile device 100 is not set to be unnecessarily high. For example, as in an emergency avoidance mode, the mobile device 100 jumps over the obstacle 192 with which the mobile device 100 may collide.

The air travel controller 156 predicts at least the behavior of the obstacle 192 in the surroundings vertically below the mobile device 100 itself in the air travel state. For example, the mobile device 100 jumps over one obstacle 192a that is located around the mobile device 100 and for which the probability of collision has been determined. Accordingly, the air travel controller 156 derives the direction of travel, the relative distance, and the relative speed of the obstacle 192a, and predicts the movement trajectory of the obstacle 192a at the timing when the mobile device 100 jumps over the obstacle 192a. The air travel controller 156 derives the period of time during which the mobile device 100 stays in mid-air and the landing point of the mobile device 100 in accordance with the predicted movement trajectory such that the movement destination of the mobile device 100 does not overlap the movement destination of at least the obstacle 192a.

As illustrated in FIG. 9, at least a pedestrian or a preceding vehicle is not present above the obstacles 192. Moving the mobile device 100 above the obstacles 192 can increase the probability of avoiding a collision with the obstacles 192.

Further, the air travel controller 156 determines whether landing conditions are satisfied, also based on the behaviors of the other obstacles 192 to land the mobile device 100 (S124). The landing conditions are, for example, that the mobile device 100 can avoid a collision with the other obstacles 192 in a landing motion (the probability of collision with the obstacles 192 is less than a predetermined probability), that a region where an area for the mobile device 100 to land is securable is present, and that the landing point is not set in a landing prohibition zone. The landing prohibition zone is a region in which the risk of landing is predicted and landing is prohibited in advance. Examples of the landing prohibition zone include a paved bridge surface, and a road constructed predetermined years ago. The air travel controller 156 maintains the air travel of the mobile device 100 while the landing conditions are not satisfied, that is, while it is determined that a collision between the mobile device 100 and any one of the other obstacles 192 is not avoidable, a region where an area for the mobile device 100 to land is securable is not present, or the landing point is set in the landing prohibition zone (NO in S124).

If it is determined that the landing conditions are satisfied (YES in S124), the air travel controller 156 identifies a landing point at which safety can be appropriately ensured (S126). In one example, the air travel controller 156 selects, as candidate landing points, regions in which no preceding vehicle is present and where an area for the mobile device 100 to land is securable, based on the surrounding information, the movement information, the attitude information, and the position information. At this time, the air travel controller 156 excludes an intersection, a lane to which the mobile device 100 moves in a direction different from the direction of travel, and the like from the candidate landing points. The air travel controller 156 preferentially selects a lane and a road shoulder in the same direction as the direction of travel as candidate landing points.

The air travel controller 156 may identify a landing point in consideration of weather conditions in the surrounding information. For example, the air travel controller 156 may increase, based on the solar intensity, a threshold for the area in which landing is available under low solar intensity conditions such as during nighttime to secure a larger region as the area in which landing is available. Alternatively, the air travel controller 156 may increase, based on the amount of precipitation or the wind speed, the threshold for the area in which landing is available when, for example, the road surface is wet because of rainfall or the wind speed is high, to secure a larger region as the area in which landing is available.

The air travel controller 156 identifies one of the candidate landing points as the landing point according to priority based on the relative distance between the landing point and the current mid-air position of the mobile device 100 and the area that can be secured at the landing point. For example, the air travel controller 156 identifies, as the landing point, a candidate landing point whose relative distance to the current mid-air position is short and at which the area that can be secured is large. At this time, the relative distance and the area may be weighted differently.

Alternatively, the air travel controller 156 may output multiple candidate landing points to the input/output unit 120 to prompt the occupant to select a landing point. The air travel controller 156 identifies the candidate landing point determined by the occupant from among the multiple candidates as the landing point. This configuration makes it possible to identify an appropriate landing point in accordance with the intention of the occupant, for example, whether to keep the mobile device 100 still traveling in the air or to temporarily land the mobile device 100.

If the occupant does not select a landing point within a predetermined time after the air travel controller 156 outputs candidate landing points to the input/output unit 120, as described above, the air travel controller 156 may identify one of the candidate landing points as the landing point according to priority based on the relative distance between the landing point and the current mid-air position of the mobile device 100 and the area that can be secured at the landing point. If the occupant does not select a landing point within a predetermined time after the air travel controller 156 outputs candidate landing points to the input/output unit 120, the air travel controller 156 may derive a candidate landing point again while maintaining the air travel of the mobile device 100.

An example has been described in which the air travel controller 156 preferentially extracts a lane and a road shoulder in the same direction as the direction of travel as landing points. However, the present invention is not limited to such a case. The air travel controller 156 may determine a predetermined place, for example, a PA (Parking Area) or an SA (Service Area) whose relative distance to the current mid-air position is short, as a landing point.

When the landing point is identified in the way described above, the air travel controller 156 causes the mobile device 100 to start the landing operation through the air travel executor 140 (S128).

In one example, the air travel controller 156 derives a three-dimensional relative distance and a relative speed between the obstacle 192 and the mobile device 100 in the surrounding information. Then, the air travel controller 156 controls the propulsion of the mobile device 100, based on the three-dimensional relative distance and the relative speed of the obstacle 192, such that the mobile device 100 does not collide with the obstacle 192. Further, the air travel controller 156 derives a three-dimensional relative distance and a relative speed of the landing point in the surrounding information. Then, the air travel controller 156 controls the propulsion of the mobile device 100, based on the three-dimensional relative distance and the relative speed of the landing point, such that the mobile device 100 can land safely. Instead of the relative speed, the absolute speed of the mobile device 100 can be applied as long as the landing point is in a state in which the position thereof does not move as in a mobile heliport. Further, the air travel controller 156 controls the propulsion of the mobile device 100, based on the three-dimensional relative distance and the relative speed of the obstacle 192 in the surrounding information, such that the mobile device 100 does not collide with the obstacle 192 after landing. Control as for an aircraft is not performed.

The air travel controller 156 may notify an external entity such as another vehicle or a person of the landing point to allow the external entity to know a position at which the mobile device 100 is to land. For example, the air travel controller 156 emits light to the entire landing point or the outer edge thereof to alert the surroundings so that the area where the mobile device 100 is to land can be understood. Alternatively, the air travel controller 156 can output a warning sound indicating that the mobile device 100 is to land to the outside, or can transmit information indicating that the mobile device 100 is to land to surrounding vehicles via vehicle-to-vehicle communication.

In some cases, when the mobile device 100 approaches the landing point, an event that prevents a safe landing operation may occur unintentionally. To address the event, the air travel controller 156 determines whether a levitation condition is satisfied during the landing operation, also based on the behaviors of the other obstacles 192 and the surrounding information (S130). Examples of the levitation condition include a condition that another new obstacle 192 is present at the identified landing point, a condition that a road surface condition at the landing point deteriorates, a condition that the wind speed at the landing point is increased, a condition that the landing point is vibrating due to an earthquake or the like, a condition that an abnormality has occurred in the mobile device 100, a condition that the occupant has some abnormality, and a condition that an abnormality has occurred in the vehicle cabin. The abnormality in the vehicle cabin includes a change in weight balance, which is caused by the movement of an occupant or a load in the vehicle cabin, and the removal of a seat belt. If any of the levitation conditions is satisfied (YES in S130), the air travel controller 156 causes the mobile device 100 to levitate again (S132) and maintains the air travel of the mobile device 100 (S122).

If it is determined that none of the levitation conditions is satisfied (NO in S130), the air travel controller 156 completes the landing of the mobile device 100 and finishes the air travel of the mobile device 100 (S134). The environment information analyzer 152 deactivates the sensor related to the environment information to be detected in the air travel state (S136).

Subsequently, the travel selector 158 returns the air travel state to the ground travel state in response to the landing of the mobile device 100 (S138). In one example, the travel selector 158 determines that the mobile device 100 has landed, based on the traveling resistance of the wheels of the mobile device 100, the load on the suspension, and the load on the motor and the wings used for air travel. Further, as illustrated in FIG. 5, the travel selector 158 changes the priority order for CAN communication from the priority order based on the air travel state to the priority order based on the ground travel state in response to the landing of the mobile device 100. Accordingly, safety can be improved.

Although a preferred embodiment of the present invention has been described with reference to the accompanying drawings, it is needless to say that the present invention is not limited to the embodiment. It will be apparent to those skilled in the art that various changes and modifications can be made without departing from the scope as defined by the appended claims and that such changes and modifications also fall within the technical scope of the present invention.

For example, in the embodiment described above, an example has been described in which priority is given to horizontal travel and propulsion in the vertically upward direction is performed when it is determined that avoidance is difficult even when horizontal travel is performed. Alternatively, the environment information analyzer 152 may always calculate safety factors for horizontal movement and vertically upward movement and move the mobile device 100 in the safest direction.

In the embodiment described above, furthermore, the technique of switching between ground travel and air travel has been described using the actual mobile device 100. However, the present invention is not limited to such a case and can also be applied to a training simulator that simulates the movement of the mobile device 100 by adopting specifications similar to those of the actual mobile device 100, and a development simulator that checks the specifications and operation of an actual component appropriately used as part of the training simulator. In this case, the training simulator or the development simulator can simulate the priority order for information transmission related to the ground travel executor 130 and the air travel executor 140.

A series of processes performed by each device (for example, the mobile device 100) according to the present embodiment described above may be implemented by using any of software, hardware, or a combination of software and hardware. A program forming the software is stored in advance in, for example, a non-transitory storage medium (non-transitory media) provided inside or outside each device. For example, the program is read from a non-transitory storage medium (for example, a ROM) to a transitory storage medium (for example, a RAM) and is executed by a processor such as a CPU.

It is possible to create a program for implementing the functions of each of the devices described above and install the program in a computer of each of the devices. In response to the processor executing the program stored in the memory, the processing of each of the functions is executed. At this time, the program may be shared and executed by multiple processors, or the program may be executed by a single processor. Alternatively, the functions of each of the devices described above may be implemented by cloud computing using multiple computers coupled to each other via a communication network. The program may be distributed from an external device via a communication network and provided and installed in the computer of each device.

### REFERENCE SIGNS LIST

100 mobile device (land-and-air mobile device)
110 environment information acquirer
120 input/output unit
130 ground travel executor
140 air travel executor
150 controller
152 environment information analyzer
154 ground travel controller
156 air travel controller
158 travel selector

1. A land-and-air mobile device comprising:
an environment information acquirer configured to acquire environment information;
a ground travel executor configured to execute ground travel;
an air travel executor configured to execute air travel; and
a controller, wherein
the controller comprises:
one or more processors; and
one or more memories coupled to the one or more processors, and
the one or more processors are configured to execute a process comprising:
selecting, based on the environment information, a ground travel state in which the ground travel is executed or an air travel state in which the air travel is executed; and
changing a priority order for information transmission related to the ground travel executor and the air travel executor in accordance with whether the ground travel state or the air travel state is selected.

2. The land-and-air mobile device according to claim 1, wherein the one or more processors are configured to perform the information transmission related to the ground travel executor and the air travel executor via CAN communication.

3. The land-and-air mobile device according to claim 1, wherein the one or more processors are configured to execute a process of changing the priority order for the information transmission related to the ground travel executor and the air travel executor, in units of frames.

4. The land-and-air mobile device according to claim 10, wherein
the ground travel executor comprises a power-unit bus and a chassis bus,
the air travel executor comprises a motor bus and a three-steering bus,
the air travel executor comprises a motor bus and a three-steering bus, and
the one or more processors are configured to execute a process of changing the priority order for the information transmission related to the ground travel executor and the air travel executor, in units of buses comprising the power-unit bus, the chassis bus, the motor bus, and the three-steering bus.

5. (canceled)

6. The land-and-air mobile device according to claim 1, wherein the one or more processors are configured to, when an obstacle in surroundings in a horizontal direction of the land-and-air mobile device is detected in the ground travel state based on the environment information and a probability of collision between the land-and-air mobile device and the obstacle in the surroundings in the horizontal direction is equal to or higher than a predetermined probability, execute a process of changing the priority order for the information transmission related to the ground travel executor and the air travel executor from a priority order based on the ground travel state to a priority order based on the air travel state and shift the land-and-air mobile device from the ground travel state to the air travel state.

7. The land-and-air mobile device according to claim 1, wherein the one or more processors are configured to
maintain, when the environment information indicates that a predetermined landing condition is not satisfied in the air travel state, the land-and-air mobile device in the air travel state, and
execute, when the environment information indicates that the predetermined landing condition is satisfied, a process of changing the priority order for the information transmission related to the ground travel executor and the air travel executor from a priority order based on the air travel state to a priority order based on the ground travel state and shift the land-and-air mobile device from the air travel state to the ground travel state.

8. The land-and-air mobile device according to claim 3, wherein
the ground travel executor and the air travel executor each comprise an ECU configured to perform the information transmission with the one or more processors via CAN communication, and
a frame type of a frame to be processed by the ECU is associated with a different CAN ID in accordance with whether the frame type is for the ground travel state or the air travel state.

9. The land-and-air mobile device according to claim 4, wherein frame types of frames including the frame to be processed by an ECU are associated with CAN IDs having priorities such that
in the ground travel state, the priorities in descending order are a frame type used for control to change a movement direction of the land-and-air mobile device, a frame type used for braking the land-and-air mobile device, and a frame type used for controlling travel of the land-and-air mobile device, and
in the air travel state, the priorities in descending order are a frame type used for control to maintain a levitation state of the land-and-air mobile device, a frame type used for control to change a movement direction of the land-and-air mobile device, and a frame type used for braking the land-and-air mobile device.

10. The land-and-air mobile device according to claim 1, wherein
the ground travel executor and the air travel executor each comprise multiple ECUs configured to perform the information transmission with the one or more processors via CAN communication, and buses configured to couple the one or more processors to the ECUs,
the buses are associated with CAN IDs indicating priorities,
the one or more processors are configured to assign a CAN ID to a frame to be transmitted to any one of the ECUs as a transmission destination and transmit the frame to an ECU as the transmission destination, the CAN ID corresponding to a bus of the buses to which the ECU as the transmission destination is coupled, and
the bus is associated with a different CAN ID in accordance with whether the bus is for the ground travel state or the air travel state.

11. The land-and-air mobile device according to claim 7, wherein the predetermined landing condition comprises at least a condition that the land-and-air mobile device does not collide with an obstacle in surroundings in a horizontal direction of the land-and-air mobile device or an obstacle in surroundings vertically below the land-and-air mobile device during a landing operation and that a landing point at which an area for the land-and-air mobile device to land is securable is present.

12. The land-and-air mobile device according to claim 11, wherein the one or more processors are configured to execute a process comprising:
deriving the landing point, and a relative distance and a relative speed between the landing point and the land-and-air mobile device in the air travel state; and
landing the land-and-air mobile device at the landing point based on a result of the deriving.

13. The land-and-air mobile device according to claim 1, wherein, when the air travel state is selected,
the environment information acquirer is configured to acquire lower-environment information of surroundings vertically below the land-and-air mobile device itself, and
the one or more processors are configured to execute a process comprising predicting a behavior of an obstacle in the surroundings vertically below the land-and-air mobile device itself, based on at least the lower-environment information.
